(19) United States
(12) Patent Application Publication
(10) Pub. No.: US 2008/0208883 A1
(43) Pub. Date: Aug. 28, 2008

(54) Method And System For A User-Customizable Interactive Physician Recall Message Database

(76) Inventors: Robert Hernandez, Philadelphia, PA (US); Ming Ding, West Chester, PA (US); Edmund Meyers, Woodlyn, PA (US)

Correspondence Address: BAKER BOTTS L.L.P., 30 ROCKEFELLER PLAZA, 44TH FLOOR, NEW YORK, NY, 10112-4498, US

(21) Appl. No.: 12/026,922

(22) Filed: Feb. 6, 2008

Related U.S. Application Data
(60) Provisional application No. 60/888,470, filed on Feb. 6, 2007.

(51) Int. Cl. G06F 17/30

(52) U.S. Cl. 707/101; 707/E17.009

(57) ABSTRACT

Techniques for analyzing physician pharmaceutical product recall messages are disclosed. In a preferred embodiment, a method is presented which involves receiving physician recall messages and inputting the messages into a searchable database. A computer program allows a user to define customized message categories. The user definitions include full-text search strings for the messages. The messages are then sorted into the customized message categories based on the definitions. Finally, the sorted messages are presented to the user.

### CROSS REFERENCE TO RELATED APPLICATIONS

This application claims priority to U.S. Provisional Application No. 60/888,470, filed on Feb. 6, 2007, which is incorporated by reference in its entirety herein.

### BACKGROUND

1. Technical Field

The present invention relates to techniques for analyzing messages describing physician recall of pharmaceutical product information, and more specifically, computerized techniques for sorting messages based on their contents.

2. Background Art

Pharmaceutical companies invest significant time and resources developing core product messages for their sales representatives to deliver to prescribers (physicians). The goal is to accurately detail the product's strengths, differentiate the product over the competition, and give the product a competitive edge. The challenge is knowing what messages the prescribers are actually hearing, what messages are effective, and what messages are resonating with the prescribers.

In order to determine what messages are heard and what messages resonate, companies recruit physicians to report their interactions with sales representatives, typically monthly or quarterly. Such reporting is done using survey instruments accessed via the internet or in paper form. These recall messages may include verbatim accounts of primary product messages, the physicians' own prescribing intentions, how many details they received, and the average number of minutes devoted to each product.

Analysts then review these messages to determine the effectiveness of the various messaging strategies. In order to analyze the messages, analysts must first spend large amounts of time sifting through hard copy message verbatims, searching, sorting, categorizing, and tallying, to gather data. This manual monthly categorization process causes a high percentage of categorization errors, limited transparency of the categorization business rules, is very time consuming, and creates a situation where the analysts have little time to analyze the categorization messages.

To reduce the amount of time analysts spend sorting messages, computer-based search systems have been utilized which allow full-text searching of the messages and sorting into standard categories. However, such computer analysis techniques are inherently inflexible, as the user may determine that the standard message categories incorporated into the program are inappropriate for the messages being analyzed. Accordingly, there exists a need for a flexible computerized technique for analyzing and sorting recall messages

### SUMMARY

An object of the disclosed invention is to provide a computerized technique for analyzing physician recall messages which allows users to define customized message categories using full-text search strings, and then sorts the messages into the categories based on the user-entered search strings.

In order to meet this and other objectives which will become apparent with reference to the disclosure herein, the present invention provides techniques for analyzing pharmaceutical product recall information.

In some embodiments, physician recall messages are received and input into a searchable database. The database may contain both a main data table and separate data tables for messages from each of the preceding 10 years. A computer program allows a user to define customized message categories through a web-based interface. These user definitions include full-text search strings for the messages. The messages are sorted into the customized message categories based on the definitions. Finally, the sorted messages are presented to the user.

The accompanying drawings, which are incorporated and constitute part of this disclosure, illustrate preferred embodiments of the invention and serve to explain the principles of the invention.

### BRIEF DESCRIPTION OF THE DRAWINGS

FIG. 1 is a functional diagram of an embodiment of a system for performing a message collection and analysis process in accordance with an aspect of the present invention.

FIG. 2 is a functional diagram illustrating an embodiment of an exemplary main message database dataload process;

FIG. 3 is a block diagram illustrating an exemplary message analysis program that may be implemented in one arrangement of the system;

FIG. 4 is an illustrative diagram of an embodiment of the user interface of the program of FIG. 3; and

FIG. 5 is a functional diagram of the interactions between the program components of FIG. 3 when attempting to retrieve data from the database in response to a user command in one embodiment of the invention.

While the present invention will now be described in detail with reference to the Figs., it is done so in connection with the illustrative embodiments.

### DETAILED DESCRIPTION

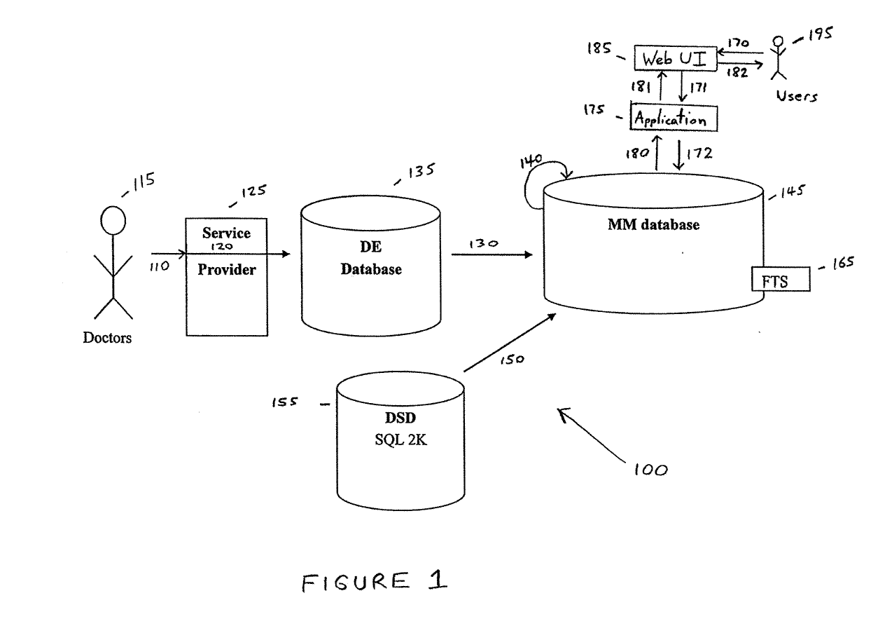

Referring to FIG. 1, there is shown an exemplary system 100, including a data entry database 135, a main message (MM) database 145, DSD Product Market Definition Tool (DSD) database 155, application 175, and web-based user interface 185. Application 175 and web-based user interface 185 are components of the message analysis program, as is main message database 145 when the program is running. In an exemplary embodiment, the data entry (DE) database 135 is an OASYS database running on an NT Unix platform, while the MM database 145 and the DSD database 155 are both run on SQL Server 2000. MM database 145 also includes a full-text searching (FTS) engine 165. In one arrangement, application 175 and web-based user interface 185 are run on Windows Server 2003 servers having Intel processors, 1 GB of RAM, and 72 GB of hard drive space, MM database 145 is run on a SQL Server 2000 server having 2 Intel processors, 2 GB of RAM, and 140 GB of hard drive storage, and DE and DSD databases 135 and 155 are run on servers having an Intel processor, 1.2 GB of RAM, and 55 GB of hard drive space.

Although the invention will now be described with reference to this exemplary embodiment, those of ordinary skill in the art will appreciate that the invention may be practiced by other than the described embodiment. For example, DE database 135 and DSD database 155 could also run on a SQL Server, an Informix server, or any other SQL server platform that may be run on an NT Unix or Windows platform. MM database 145 could be run on any database server that has Extract, Transform, Load (ETL) and text search capabilities or may be integrated into DE database 135.

As shown in FIG. 1, doctors 115 send information 110 to the service provider as paper forms or through a website. Next, 120, the service provider (IMS) 125 enters the survey data into DE database 135. DE database 135 is the source of all data for the system. A dataload process 130, an ETL procedure, is executed which copies all of the data from the DE database 135 into staging tables in the MM database 145 using DTS. A stored procedure is then used 140 to update the MM database 145 production tables. The DSD database 155 is linked to the MM database 145. The DSD database 155 contains information which is used to determine the market definition and data date ranges for each user 195 that accesses the system. Each user's access may thereby be limited to messages concerning a particular market and a particular date range. When a user 195 logs in, the information is read 150 from the DSD database 155 and transmitted to MM database 145.

The MM database includes a main message table, which stores all of the messages and all of their associated information in an accessible form, and then annual messages tables, each of which store physician messages for a particular year. The annual messages tables store a reduced amount of information for each message, but allow full-text searching of the message text. The main message table should include columns to store (among other things): an ID number, location, and specialty of each doctor; the date, vendor name, product, and length of each sales representative contact; the primary product message and category of the product mentioned; and the message ID number. Each annual messages table contains columns storing the time period identifier, the product ID number, the text of the primary product message, a specialty code, and a message ID.

The system uses a FTS engine 165, which is part of MM database 145, to build indexes on the message records. The indexes allow easy searching of message attributes and quick retrieval of messages from the database. FTS is very powerful and flexible, but queries can be slow if the catalog of messages grows too large, and the catalogs are also slow to index from scratch. In order to avoid these issues, the MM database 145 incorporates certain features. The MM database 145 can contain messages going back many years. Users may only be interested in data from certain years, however. Therefore, the message data is copied into the annual messages tables based on the date of the data. For example, data from 2000 is stored in the Year 2000 messages table, data from 2001 in the Year 2001 messages table, and so on. When performing FTS queries to sort messages into categories, a separate query is executed for each year included in the search.

Users 195 access the system 170 through a web-based user interface 185 and enter a request for data. In a preferred embodiment, web-based user interface 185 is enacted using Extensible Markup Language (XML), but could also be enacted using JavaScript. Next, 171, a user interface 185 communicates the user request to an application 175 which handles all communication between the user interface 185 and the database 145. An application 175 activates a stored procedure 172 in database 145 to carry out the user request. The stored procedure transmits data 180 responsive to the request to application 175. An Application 175 transfers the responsive data at 181 to user interface 185. At 182, user interface 185 presents the responsive data to user 195.

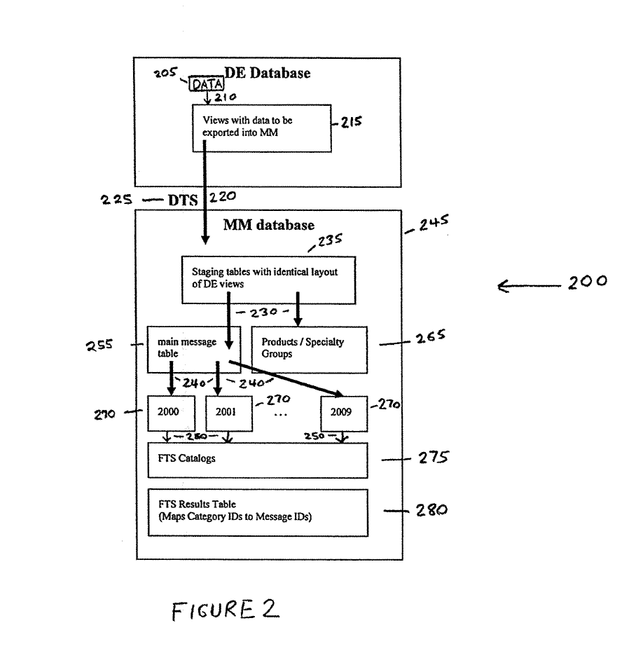

Referring next to FIG. 2, an exemplary dataload process will be described. The dataload process is run monthly at a time when there are few users trying to access the database. In a preferred embodiment, the dataload program is a Windows NT program which performs the following actions. At 210, data 205 intended for MM 245 is placed in special views 215 that include only survey data with messages and relevant descriptor data in the DE database. At 220, the dataload program executes a DTS (data transformation services) package 225 which copies all of the data from the DE database views 215 into staging tables 235 in the MM database 245 with identical structures. In 230, stored procedures executed during the dataload process copy and/or massage data into the main message table 255 and Products/Specialty Groups tables 265.

At 240, data in the main message table is copied into the annual messages tables 270 based on the year of the message. At 250, full-text search (FTS) catalogs 275 are rebuilt in SQL Server 2000 for each annual messages table 270 that had data updates. If no data changed in that table, the existing catalog is retained. The FTS engine parses the words in the text of each message and creates an index correlating each word to the messages that contain it. These indexes are stored in FTS catalogs 275 and user FTS queries are run against the catalogs 275 rather than through the entire text of each message in order to speed up queries. At 260, the FTS results table 280 maps individual messages to specific user categories. The FTS queries are re-executed for each category, and the results are placed in this table.

During the dataload process, the annual messages tables 270 are only updated from data in the main message 255 table if the data has changed. The FTS catalog 275 is entirely rebuilt for the catalogs that have changed. Because it is extremely rare for previous data to change, in the vast majority of cases, only one annual messages table catalog index needs to be rebuilt during a dataload, greatly reducing the time needed.

Instead of executing FTS queries every time a report is run, the system may cache the results of each FTS query in the FTS results table 280. This table links category ids to message ids. An individual set of records are updated when the user modifies a category query. The contents of the entire table are dropped and rebuilt during the dataload process.

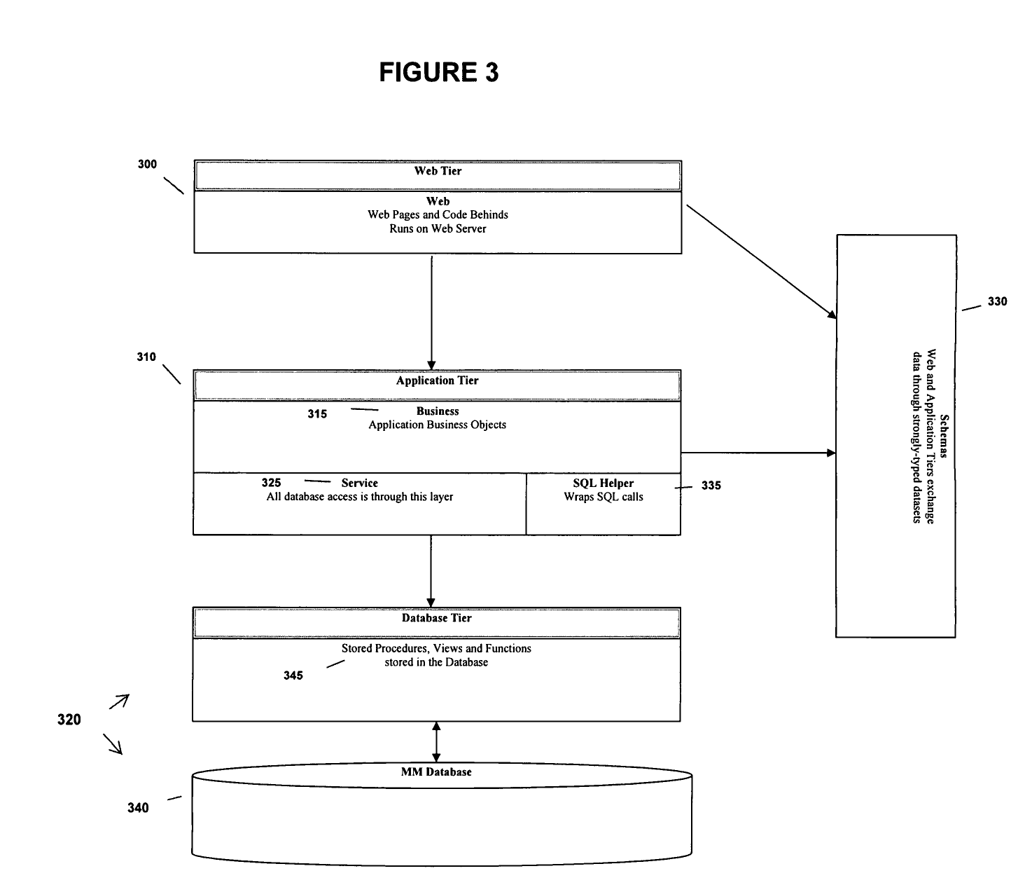

Referring next to FIG. 3, the interaction and relationship of the components of the message analysis program is represented. Users access the message analysis program through a web interface. The system may be created using four logical tiers, the Web/UI (user interface) tier, the Business tier, the Service Tier, and the aforementioned Database Tier. However, the system may be deployed on a single tier, or deployed across all four tiers. In a preferred embodiment, the system is deployed across three tiers, a Web Tier, and Application Tier, and a Database Tier. Each logical tier and different subsystems may be broken apart into separate assemblies.

The Web Tier 300 and Application Tier 310 may be operated on Windows Server 2003 servers running version 1.1 of the Microsoft .NET framework, while the Database Tier 320 may be operated on a SQL Server 2000 server. The Web Tier server contains a configuration file that tells the Web Tier Server which Application Tier server to use, while the Application Tier server contains a similar configuration file which tells the Application Tier server how to connect to the Database Tier server.

The Web 300 and Application 310 Tiers of the program communicate using Schema namespace 330, which contains data wrappers. The data wrappers mostly consist of strongly typed datasets, but can also contain class wrappers. Every schema object should be serializable. Schema objects should represent, and thus document, all data that is passed from the application server to the web server.

The Web Tier 300 of the program contains the user interface for the system. As much as possible, business rules and logic should exist in the Application Tier 310. The Web Tier 300 should be limited to only UI components. Web Tier 300 may include validators and other javascript functions, but the Application Tier 310 should not require such code to be present in order to work properly.

In one arrangement, Application Tier 310 may contain Business objects 315, Service Objects 325, and an SQL Helper 335 to wrap SQL calls. Business objects 315 are single-call Microsoft .NET remoting objects that contain business logic and are methods for saving, loading, or validating data. While the system is operating, Web Tier 300 collects inputs from the end user, such as which report they are looking at and the filters on the report (date, products, categories, specialties, etc.) and passes them Application Tier 310. Business objects 315 then decide which procedures to call to retrieve the requested data from database 340 using the business logic, fetch the data, and return it to Web Tier 300. They deal with data stored in Schema objects 330. They use Service objects 325 to read and/or write from the database.

Service objects 325 are the only objects in the application that can communicate directly with the Database Tier 320. They should be limited to functions of loading and saving data, and should not be concerned with any logic validating data or enforcing business rules.

Database Tier 320 includes stored procedures 345 and the MM database 340.

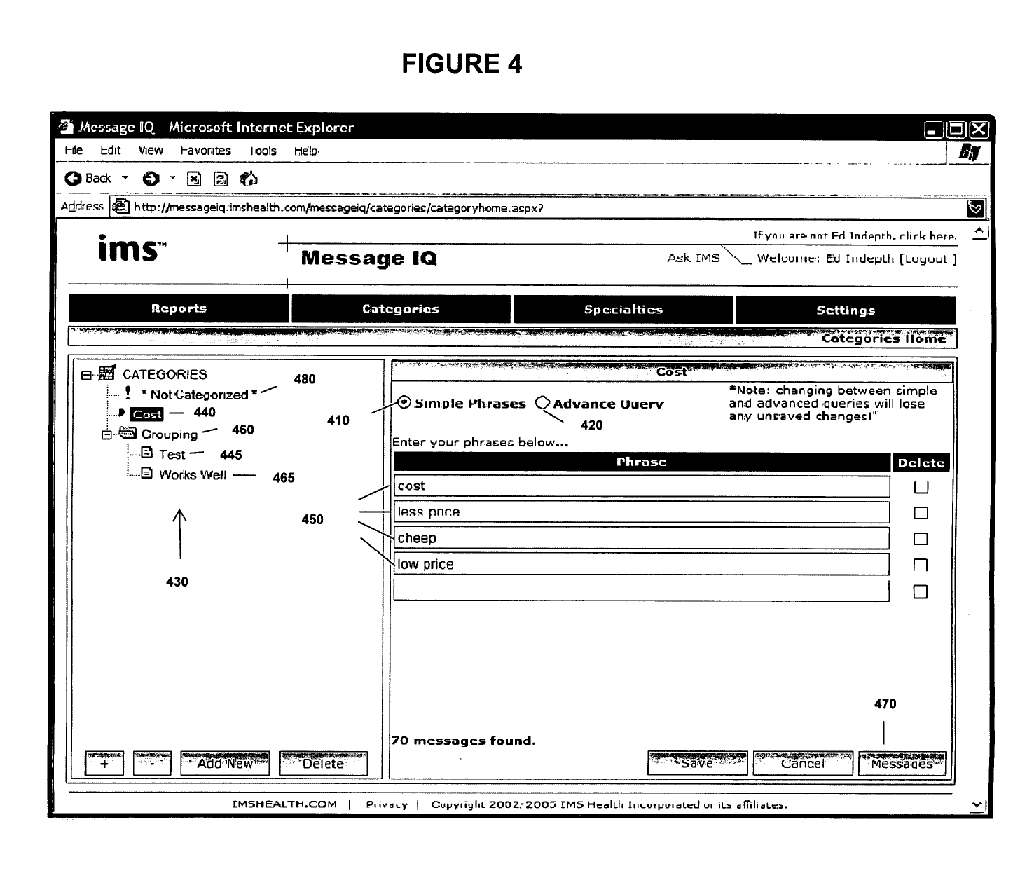

FIG. 4 is a representation of a message categories page viewed by a user on the web-based user interface of the message analysis program which runs on the Web Tier. Each user may define custom categories specific only to him. Such categories may be layered, creating sub-categories and sub-categories of sub-categories, and so forth. Messages can map to multiple categories if they are relevant to more than one category. The user can enter two types of queries, Simple Phrases 410 and Advance Query 420. Examples of Simple Phrases include strings such as “low cost,” “effective,” or “non-toxic.” Messages are mapped to Simple Phrases if any one of the search phrases are found somewhere in the message text. Selection of Advance Query 420 allows the user to write FTS queries using boolean operators such as ANDs, ORs, NOTs, and parentheses. Advance Queries include strings such as “low cost AND effective,” or “non-toxic OR low cost.” On the left side of the page, a tree diagram 430 depicts the structure and relationship of the user-defined categories 440 and 460, and sub-categories 445 and 465. In this example, the currently-selected category “cost” 440, is highlighted in the tree diagram, while the FTS queries 450 entered by the user that map messages to the “cost” category 440 are displayed on the right side of the page.

If the Messages button 470 is selected, a dialog box appears, displaying all of the messages associated with the currently-selected category. When the currently selected category is Not Categorized 480, selecting Messages button 470 will display all of the messages that are not assigned to any category.

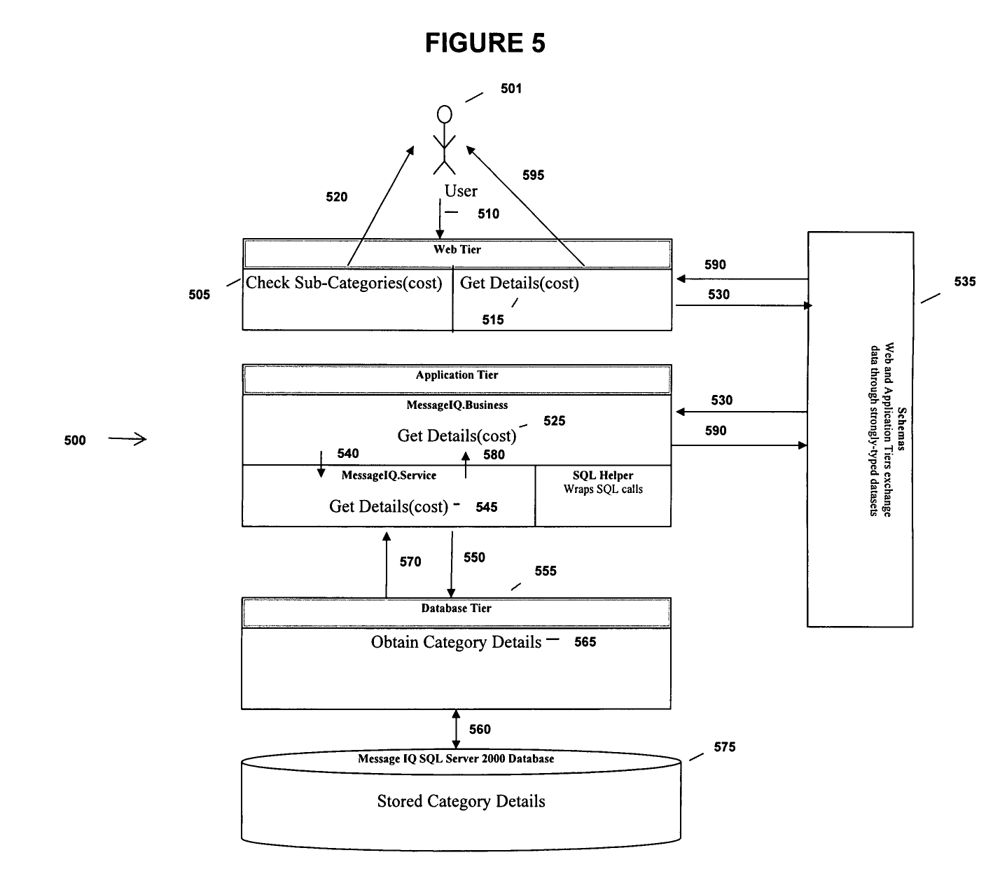

Referring next to FIG. 5, an example of one arrangement of the interaction between the various program Tiers will be described with reference to the diagram 500. In 510, a user, operating through the web interface, selects the category “cost” in the category tree display on the category page. Then, in 520, the Web Tier object Check Sub-Categories(cost) 505 would select the category and all sub-categories on the display in response. Because selection of a category in the category tree displays the category details as well, a Web Tier object Get Details(cost) 515 is run. In 530, Get Details(cost) 515 calls the Application tier Business object Get Details(cost) 525 using Schemas 535 to get the details and FTS query for the cost category. Next, in 540, Get Details(cost) 525 calls the corresponding Get Details(cost) Service object 545.

In 550, Get Details(cost) 545 communicates with the Database Tier 555 and invokes the stored procedure Obtain Category Details 565. In 560, Obtain Category Details 565 fetches the category details from the database 575. In 570, Obtain Category Details 565 returns the details to the Service object Get Details(cost) 545 in the Application Tier. In 580, the Service object Get Details(cost) 545 then produces a “Category Details” dataset and returns it to the Business object Get Details(cost) 525. Next, in 590, Business object Get Details(cost) 525 transmits the dataset to the Web Tier using Schemas 535. Finally, in 595, the Web Tier displays the retrieved category details to the user.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

We claim:

1. A method for analyzing product recall messages and sorting the messages into categories, comprising:
(a) receiving one or more recall messages;
(b) inputting the one or more messages into one or more searchable databases;
(c) defining one or more customized message categories, each comprising full-text search strings for the one or more messages; and
(d) sorting the one or more messages into the one or more customized message categories based on the definitions.

2. The method of claim 1 wherein said inputting the messages into a searchable database comprises:
(e) inputting the messages into a data entry database;
(f) transferring the messages into staging tables in a searchable database; and
(g) updating production tables in the searchable database with the messages stored in the staging tables.

3. The method of claim 2 further comprising:
(h) providing a data table for each of the preceding 10 years; and
(i) copying each of the messages into a data table based on the year the message was sent.

4. The method of claim 1 wherein the messages are pharmaceutical product recall messages.

5. The method of claim 4 wherein the pharmaceutical product recall messages are physician pharmaceutical product recall messages.

6. The method of claim 1 wherein the messages include a doctor identification number.

7. The method of claim 1 wherein the messages include a product identification code.

8. The method of claim 1 wherein the messages include a specialty identification code.

9. The method of claim 1 wherein the full-text search strings include boolean operators.

10. The method of claim 1 wherein said defining one or more customized message categories is conducted by one or more users, each user having an associated pharmaceutical market and message date range.

11. The method of claim 10 wherein the user is restricted to searching only those messages associated with the user's pharmaceutical market and message date range.

12. The method of claim 1 wherein the database is an SQL database.

13. The method of claim 1 wherein the wherein said defining one or more customized message categories is conducted by one or more users through a web-based interface.

14. A system for analyzing product recall messages and sorting the messages into categories, comprising:
(a) at least one input device for transferring one or more recall messages into one or more searchable databases;
(b) at least one database coupled to the at least one input device for storing the one or more messages;
(c) at least one processor coupled to the at least one database; and
(d) a computer readable medium coupled to the at least one processor, having stored thereon instructions which when executed cause the at least one processor to:
allow a user to define one or more customized message categories, each comprising full-text search strings for the one or more messages; and
sort the one or more messages into the one or more customized message categories based on the definitions.

15. The system of claim 14 wherein the database further comprises:
(e) a data entry database for receiving messages from the input device and transferring the messages to a searchable database; and
(f) a searchable database including staging tables for receiving the messages from the data entry database and production tables, the staging tables updating the production tables with the messages received from the data entry database;
transferring the messages into staging tables in a searchable database.

16. The system of claim 15 wherein the searchable database includes data tables for each of the preceding 10 years, the database allowing copying of each of the messages into a data table based on the year the message was sent.

17. The system of claim 14 wherein the messages are pharmaceutical product recall messages.

18. The system of claim 17 wherein the pharmaceutical product recall messages are physician pharmaceutical product recall messages.

19. The system of claim 14 wherein the messages include a doctor identification number.

20. The system of claim 14 wherein the messages include a product identification code.

21. The system of claim 14 wherein the messages include a specialty identification code.

22. The system of claim 14 wherein the full-text search strings include boolean operators.

23. The system of claim 14 wherein each user has an associated pharmaceutical market and message date range.

24. The system of claim 14 wherein the user is restricted to searching only those messages associated with the user's pharmaceutical market and message date range.

25. The system of claim 14 wherein the database is an SQL database.

26. The system of claim 14 wherein the user accesses the system through a web-based interface.
